(19) United States
(12) Patent Application Publication
(10) Pub. No.: US 2025/0290835 A1
(43) Pub. Date: Sep. 18, 2025

(54) SPECIMEN TREATMENT APPARATUS

(71) Applicant: SHIMADZU CORPORATION, Kyoto-shi (JP)

(72) Inventor: Tatsuya IWAMA, Kyoto-shi (JP)

(21) Appl. No.: 19/071,117

(22) Filed: Mar. 5, 2025

(30) Foreign Application Priority Data
Mar. 14, 2024 (JP) 2024-039871

(51) Int. Cl. G01N 1/34; G01N 35/00; G01N 35/10

(52) U.S. Cl. CPC G01N 1/34; G01N 35/1072; G01N 2035/00495

(57) ABSTRACT

A specimen treatment apparatus may include a centrifugation device including a plurality of vial holders, the plurality of vial holders being arranged evenly on a same circumference an operating device holding two dispensers, the two dispensers being arranged side by side in parallel with each other in a state where ends of the two dispensers face vertically downward, the operating device being configured to simultaneously move the two dispensers, and a controller configured to control operations of the centrifugation device and the operating device, wherein a distance between the ends of the two dispensers is substantially the same as a distance between centers of two vial holders disposed parallel to an alignment direction of the two dispensers by the centrifugation device, and the controller is configured to dispose two vial holders holding vials to be accessed by the two dispensers in parallel with the alignment direction by controlling the centrifugation device, and to cause the two dispensers to simultaneously access the two vials to be accessed disposed in parallel with the alignment direction by controlling the operating device.

### BACKGROUND OF THE INVENTION

### 1. Field of the Invention

The present invention relates to a specimen treatment apparatus for performing pretreatment or the like on a specimen to be analyzed.

### 2. Description of the Related Art

There is an apparatus that automatically performs pretreatment including centrifugation treatment on a specimen such as blood. Some of such apparatuses are configured such that a plurality of vials containing a specimen are set on the same circumference, and centrifugation treatment on the specimen in the plurality of vials can be simultaneously performed (see Patent Literature 1).

### PRIOR ART DOCUMENTS

### Patent Literature

Patent Literature 1: JP 2023-041904 A

### SUMMARY OF THE INVENTION

The apparatus as described above, in which the centrifugation treatment on the specimens in the plurality of vials is simultaneously performed, has improved the efficiency of the centrifugation treatment on a plurality of specimens. However, treatment such as addition of a reagent into a specimen in a vial needs to be performed one by one, and there is a limit to efficiency improvement of treatment other than centrifugation treatment on a plurality of specimens.

The present invention has been made in view of the above problem, and an object thereof is to improve the efficiency of a series of treatment on a plurality of specimens to be subjected to analysis.

A specimen treatment apparatus according to the present invention includes:
a centrifugation device including a plurality of vial holders for holding vials each containing a specimen, the plurality of vial holders being arranged evenly on a same circumference, the centrifugation device being configured to perform centrifugation on the specimen in the vials held by the plurality of vial holders by rotating the plurality of vial holders along the circumference;
an operating device that holds two dispensers configured to suck and dispense a liquid from their ends, the two dispensers being arranged side by side in parallel with each other in a state where the ends face vertically downward, the operating device being configured to simultaneously move the two dispensers in a horizontal direction and in a vertical direction; and
a controller configured to control operations of the centrifugation device and the operating device,
wherein a distance between the ends of the two dispensers is substantially the same as a distance between centers of two vial holders disposed parallel to an alignment direction of the two dispensers by the centrifugation device among the plurality of vial holders, and
the controller is configured to dispose two vial holders, among the plurality of vial holders, holding vials to be accessed by the two dispensers in parallel with the alignment direction by controlling the centrifugation device, and to cause the two dispensers to simultaneously access the two vials to be accessed disposed in parallel with the alignment direction by controlling the operating device.

Here, the distance between the ends of the two dispensers being “substantially the same” as the distance between the centers of the two vial holders disposed parallel to the alignment direction of the two dispensers does not necessarily mean to be strictly the same, and the distance between the ends of the two dispensers may be any distance designed such that the ends of the two dispensers can simultaneously access the two vial holders disposed parallel to the alignment direction of the two dispensers. The same applies to “substantially the same” described later.

According to the specimen treatment apparatus according to the present invention, the distance between the ends of the two dispensers provided in the operating device is substantially the same as the distance between the centers of the two vial holders disposed parallel to the alignment direction of the two dispensers among the plurality of vial holders provided in the centrifugation device, and the two dispensers can simultaneously access the two vials held by the two vial holders. Thus, treatment such as addition of a reagent to the vial set in the centrifugation device can be executed at high speed. This can improve the efficiency of a series of treatment on a plurality of specimens to be analyzed.

### BRIEF DESCRIPTION OF THE DRAWINGS

FIG. 1 is a plan view illustrating a configuration of an example of a specimen treatment apparatus as viewed from above;

FIG. 2 is a conceptual diagram for describing a relationship between an dispenser of an operating device, two vial holders of a centrifugation device, two reagent containers of a reagent part, and two waste liquid containers of a waste liquid part in the example; and

FIG. 3 is a block diagram illustrating an example of a control system according to the example.

### DETAILED DESCRIPTION OF THE INVENTION

Hereinafter, an example of a specimen treatment apparatus according to the present invention will be described with reference to the drawings.

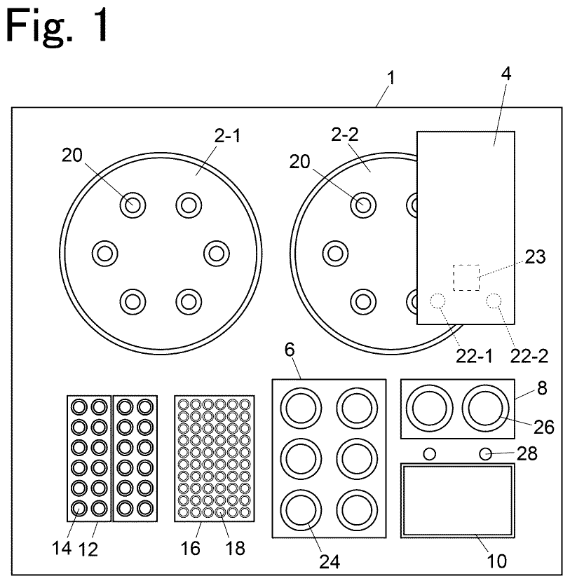

As illustrated in FIG. 1, a specimen treatment apparatus 1 includes centrifugation devices 2-1 and 2-2, an operating device 4, a reagent part 6, a waste liquid part 8, and a tip disposal part 10. In the specimen treatment apparatus 1, a vial rack 12 holding a plurality of vials 14 and a tip rack 16 holding a plurality of dispensing tips 18 are disposed.

Each of the centrifugation devices 2-1 and 2-2 has a plurality of (six in this example) vial holders 20 evenly arranged on the same circumference. Each vial holder 20 holds a vial 14 containing a specimen. The centrifugation devices 2-1 and 2-2 rotate the respective vial holders 20, thereby performing centrifugation treatment on the specimens in the vials 14 held by the vial holders 20.

The operating device 4 includes two dispensers 22-1 and 22-2 and a conveyance hand 23. The dispensers 22-1 and 22-2 suck and dispense liquids from the ends independently of each other, and are held in the operating device 4 in parallel with each other in a state where the ends face vertically downward. The conveyance hand 23 is for gripping the sample vial 14. The operating device 4 is configured to move in a horizontal direction and to independently move the dispensers 22-1 and 22-2 and the conveyance hand 23 in a vertical direction. The centrifugation devices 2-1 and 2-2, the reagent part 6, the waste liquid part 8, the tip disposal part 10, the vial rack 12, and the tip rack 18 are disposed within the movement range of the operating device 4.

A plurality of reagent containers 24 are disposed in the reagent part 6. In this example, two reagent containers 24 containing the same type of reagent are arranged side by side in a direction parallel to an alignment direction (left-right direction in the drawing) of the dispensers 22-1 and 22-2 of the operating device 4, and a total of six reagent containers 24 are arranged in three rows.

In the waste liquid part 8, two waste liquid containers 26 for receiving the waste liquid discharged from the dispensers 22-1 and 22-2 of the operating device 4 are arranged side by side in parallel with the alignment direction of the dispensers 22-1 and 22-2.

The tip disposal part 10 is a box for receiving used dispensing tips 18. In the vicinity of the tip disposal part 10, two protrusions 28 for detaching the dispensing tip 18 from the dispensers 22-1 and 22-2 are provided. Each of the dispensers 22-1 and 22-2 is provided with a mechanism (not illustrated) that lowers the dispensers 22-1 and 22-2 and presses the protrusion 28 to automatically separate the dispensing tip 18 from the dispensers 22-1 and 22-2.

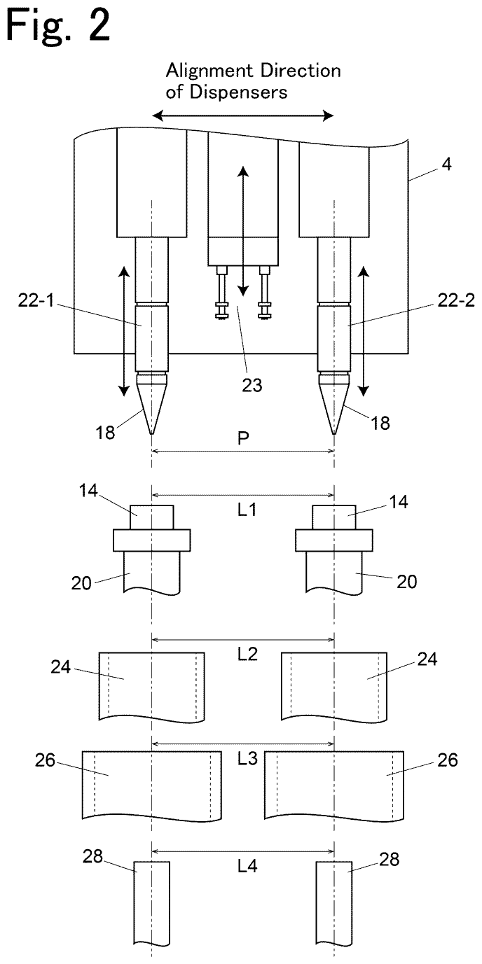

As illustrated in FIG. 2, an interval P between the ends of the dispensers 22-1 and 22-2 of the operating device 4 is substantially the same as a distance L1 between the centers of two vial holders 20 adjacent to each other among the plurality of vial holders 20 provided in each of the centrifugation devices 2-1 and 2-2. Thus, for example, by disposing the centrifugation devices 2-1 or 2-2 such that two vial holders 20 adjacent to each other are arranged in parallel with the alignment direction of the dispensers 22-1 and 22-2, the dispensers 22-1 and 22-2 can be made to simultaneously access the vials 14 held by the two vial holders 20.

The two vial holders having a distance between the centers substantially the same as the interval P between the ends of the dispensers 22-1 and 22-2 are not necessarily two vial holders 20 “adjacent to each other” among the plurality of vial holders 20 provided in each of the centrifugation devices 2-1 and 2-2. The distance between the centers of two vial holders 20 that may be disposed in parallel with the alignment direction of the dispensers 22-1 and 22-2 among the plurality of vial holders 20 provided in each of the centrifugation devices 2-1 and 2-2 may be substantially the same as the interval P between the ends of the dispensers 22-1 and 22-2. Such an aspect also allows simultaneous access of the dispensers 22-1 and 22-2 to the vials 14 held in the two vial holders 20.

In addition, as illustrated in FIG. 2, the interval P between the ends of the dispensers 22-1 and 22-2 of the operating device 4 is substantially the same as a distance L2 between the centers of two reagent containers 24 arranged side by side in parallel with the alignment direction of the dispensers 22-1 and 22-2 in the reagent part 6. With this configuration, the operating device 4 can cause the dispensers 22-1 and 22-2 to simultaneously access the two reagent containers 24 containing the same type of reagent, and can cause the dispensers 22-1 and 22-2 to simultaneously suck the same type of reagent.

The reagent part 6 does not have to be provided with two reagent containers 24 containing the same reagent. One reagent container 24 may be provided for one reagent, and the opening width of the upper surface of each reagent container 24 may be wider than the interval P between the ends of the dispensers 22-1 and 22-2. Such an aspect also allows simultaneous access of the dispensers 22-1 and 22-2 to the containers 24 containing the same reagent.

Here, since the operating device 4 can operate the dispensers 22-1 and 22-2 independently of each other, the operating device can also cause each of the dispensers 22-1 and 22-2 to suck reagents different from each other.

The interval P between the ends of the dispensers 22-1 and 22-2 of the operating device 4 is substantially the same as a distance L3 between the centers of the two waste liquid containers 26 of the waste liquid part 8 and a distance L4 between the centers of the two protrusions 28 provided in the vicinity of the tip disposal part 10. With this configuration, the operating device 4 can cause the dispensers 22-1 and 22-2 to simultaneously access the two waste liquid containers 26 and simultaneously discharge the waste liquid from the dispensers 22-1 and 22-2 to the waste liquid containers 26, and further, can simultaneously discard used dispensing tips 18 attached to the dispensers 22-1 and 22-2 to the tip disposal part 10.

The waste liquid part 8 does not have to be provided with two waste liquid containers 26. For example, one waste liquid container 26 may be provided, and the opening width of the top surface of the waste liquid container may be wider than the interval P between the ends of the dispensers 22-1 and 22-2. Such an aspect also allows simultaneous access of the dispensers 22-1 and 22-2 to the waste liquid containers 26.

With the above configuration, treatment such as suction of a reagent, dispensing of a reagent into the vial 14, collection of a specimen from the vial 14, discharge of a waste liquid to the waste liquid container 26, and disposal of used dispensing tips 18 to the tip disposal part 10 can be executed by simultaneously using the dispensers 22-1 and 22-2.

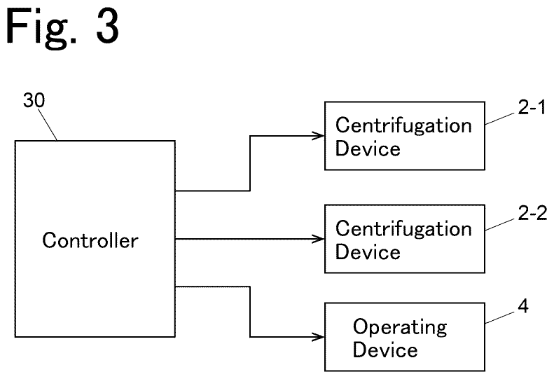

As illustrated in FIG. 3, although not illustrated in FIG. 1, the specimen treatment apparatus 1 includes a controller 30 that controls the operations of the centrifugation devices 2-1 and 2-2 and the operating device 4. The controller 30 can be realized by an electronic circuit including a central processing unit (CPU).

An example of the operation of the specimen treatment apparatus 1 is as follows.

A vial rack 12 holding vials 14 containing a specimen and a vial rack 12 holding empty vial 14 are set at predetermined positions in the specimen treatment apparatus 1. When an instruction to start treatment is input to the controller 30, the controller 30 controls the centrifugation devices 2-1 and 2-2 and the operating device 4 to sequentially convey the vials 14 containing the specimen from the set vial rack 12 to the respective vial holder 20 of the centrifugation devices 2-1 and 2-2.

When the conveyance of the vials 14 to the vial holders 20 is completed, the controller 30 adds a predetermined reagent to the vials 14 held by the centrifugation devices 2-1 and 2-2. At this time, the controller 30 determines two vials 14 (vials 14 to be accessed) to which the reagent is to be added, controls the operations of the centrifugation devices 2-1 and 2-2, arranges the two vials 14 to be accessed in parallel with the alignment direction of the dispensers 22-1 and 22-2, and simultaneously causes the dispensers 22-1 and 22-2 that have sucked the reagent to access the two vials 14 to be accessed to simultaneously add the reagent.

Thereafter, the controller 30 rotates the centrifugation devices 2-1 and 2-2 to perform centrifugation treatment on the specimen in the respective vials 14. When the centrifugation treatment is completed, the controller 30 collects the supernatant liquid in the vials 14 respectively held by the vial holders 20 of the centrifugation devices 2-1 and 2-2. At this time, the controller 30 determines two vials 14 (vials 14 to be accessed) from which the supernatant liquid is to be collected, controls the operations of the centrifugation devices 2-1 and 2-2, arranges the two vials 14 to be accessed in parallel with the alignment direction of the dispensers 22-1 and 22-2, and simultaneously causes the dispensers 22-1 and 22-2 to access the two vials 14 to be accessed to simultaneously suck the supernatant liquid. The sucked supernatant liquid can be respectively dispensed into empty vials 14 held in the vial rack 12 as samples to be subjected to analysis.

In the middle of the above treatment, the controller 30 can execute treatment such as discharge of a waste liquid from the dispensers 22-1 and 22-2 to the waste liquid containers 26, attachment of the dispensing tips 18 to the ends of the dispensers 22-1 and 22-2, and disposal of used dispensing tips 18 attached to the dispensers 22-1 and 22-2 to the disposal tip box 10 as necessary. Discharge of the waste liquid into the waste liquid containers 26 and disposal of used dispensing tips 18 into the disposal tip box 10 can be simultaneously executed using the dispensers 22-1 and 22-2.

Since the operating device 4 can operate the dispensers 22-1 and 22-2 independently of each other, it is also possible to execute treatment such as addition of a reagent to the vial 14, collection of a supernatant liquid from the vial 14, discharge of a waste liquid to the waste liquid container 26, and disposal of used dispensing tip 18 to the waste chip box 10 using only one of the dispensers 22-1 and 22-2 as necessary.

In this example, the alignment of the vials 14 in the vial rack 12 and the alignment of the dispensing tips 18 in the tip rack 16 are not configured such that the two dispensers 22-1 and 22-2 can simultaneously execute treatment such as dispensing of the supernatant liquid into the vial 14 and mounting of the dispensing tips 18 on the dispenser, but each of the racks 12 and 16 may be designed to enable simultaneous treatment with the two dispensers 22-1 and 22-2.

The example described above is merely an example of the embodiments of the specimen treatment apparatus according to the present invention. The embodiments of the specimen treatment apparatus according to the present invention are as follows.

An embodiment of the specimen treatment apparatus according to the present invention includes:
a centrifugation device including a plurality of vial holders for holding vials each containing a specimen, the plurality of vial holders being arranged evenly on a same circumference, the centrifugation device being configured to perform centrifugation on the specimen in the vials held by the plurality of vial holders by rotating the plurality of vial holders along the circumference;
an operating device that holds two dispensers configured to suck and dispense a liquid from their ends, the two dispensers being arranged side by side in parallel with each other in a state where the ends face vertically downward, the operating device being configured to simultaneously move the two dispensers in a horizontal direction and in a vertical direction; and
a controller configured to control operations of the centrifugation device and the operating device,
wherein a distance between the ends of the two dispensers is substantially the same as a distance between centers of two vial holders disposed parallel to an alignment direction of the two dispensers by the centrifugation device among the plurality of vial holders, and
the controller is configured to dispose two vial holders, among the plurality of vial holders, holding vials to be accessed by the two dispensers in parallel with the alignment direction by controlling the centrifugation device, and to cause the two dispensers to simultaneously access the two vials to be accessed disposed in parallel with the alignment direction by controlling the operating device.

In a first aspect of the embodiment described above, a distance between the ends of the two dispensers is substantially the same as a distance between centers of two vial holders adjacent to each other among the plurality of vial holders.

A second aspect of the embodiment described above further includes a reagent part in which reagent containers each containing a reagent to be added to a specimen are disposed, wherein the reagent part is configured such that the two dispensers of the operating device can simultaneously access the reagent containers containing the same type of reagent. Such an aspect can simultaneously execute suction of the same reagent with the two dispensers and can improve the efficiency of treatment on a plurality of specimens. The second aspect can be freely combined with the first aspect.

In the second aspect, the reagent part may be configured such that two containers containing the same type of reagent are disposed in parallel with the alignment direction, and in such a case, a distance between centers of the two containers containing the same type of reagent can be substantially the same as the distance between the ends of the two dispensers.

A third aspect of the embodiment described above further includes a waste liquid part configured to be simultaneously accessed by the two dispensers of the operating device and able to receive a waste liquid discharged from the two dispensers. Such an aspect can simultaneously discard the waste liquid with the two dispensers and improve the efficiency of waste liquid treatment. The third aspect can be freely combined with the first aspect and/or the second aspect.

In a fourth aspect of the embodiment described above, each of the two dispensers are configured to suck and dispense a liquid in a state where a tip is attached to the end, and the specimen treatment apparatus includes a tip disposal part configured to be simultaneously accessed by the two dispensers and able to receive the tip removed from each of the two dispensers. Such an aspect can simultaneously execute disposal treatment for used tips with the two dispensers and improve the efficiency of the disposal treatment for used tips. The fourth aspect can be freely combined with the first aspect, the second aspect, and/or the third aspect.

In a fifth aspect of the embodiment described above, the operating device is configured to suck and dispense a liquid with the two dispensers independently of each other and to move the two dispensers independently of each other in a vertical direction. Such an aspect can execute treatment such as addition of a reagent to a vial and suction of a supernatant liquid using only one dispenser. The fifth aspect can be freely combined with the first aspect, the second aspect, the third aspect, and/or the fourth aspect.

### DESCRIPTION OF REFERENCE SIGNS

1 specimen treatment apparatus
2-1, 2-2 centrifugation device
4 operating device
6 reagent part
8 waste liquid part
10 tip disposal part
12 vial rack
14 vial
16 tip rack
18 dispensing tip
20 vial holder
22-1, 22-2 dispenser
23 conveyance hand
24 reagent container
26 waste liquid container
28 protrusion
30 controller

What is claimed is:

1. A specimen treatment apparatus comprising:
a centrifugation device including a plurality of vial holders for holding vials each containing a specimen, the plurality of vial holders being arranged evenly on a same circumference, the centrifugation device being configured to perform centrifugation on the specimen in the vials held by the plurality of vial holders by rotating the plurality of vial holders along the circumference;
an operating device that holds two dispensers configured to suck and dispense a liquid from their ends, the two dispensers being arranged side by side in parallel with each other in a state where the ends face vertically downward, the operating device being configured to simultaneously move the two dispensers in a horizontal direction and in a vertical direction; and
a controller configured to control operations of the centrifugation device and the operating device,
wherein a distance between the ends of the two dispensers is substantially the same as a distance between centers of two vial holders disposed parallel to an alignment direction of the two dispensers by the centrifugation device among the plurality of vial holders, and
the controller is configured to dispose two vial holders, among the plurality of vial holders, holding vials to be accessed by the two dispensers in parallel with the alignment direction by controlling the centrifugation device, and to cause the two dispensers to simultaneously access the two vials to be accessed disposed in parallel with the alignment direction by controlling the operating device.

2. The specimen treatment apparatus according to claim 1, wherein a distance between the ends of the two dispensers is substantially the same as a distance between centers of two vial holders adjacent to each other among the plurality of vial holders.

3. The specimen treatment apparatus according to claim 1, further comprising a reagent part in which reagent containers each containing a reagent to be added to a specimen are disposed,
wherein the reagent part is configured such that the two dispensers of the operating device can simultaneously access the reagent containers containing the same type of reagent.

4. The specimen treatment apparatus according to claim 3, wherein the reagent part is configured such that two containers containing the same type of reagent are disposed in parallel with the alignment direction, and a distance between centers of the two containers containing the same type of reagent is substantially the same as the distance between the ends of the two dispensers.

5. The specimen treatment apparatus according to claim 1, further comprising a waste liquid part configured to be simultaneously accessed by the two dispensers of the operating device and able to receive a waste liquid discharged from the two dispensers.

6. The specimen treatment apparatus according to claim 1, wherein
each of the two dispensers are configured to suck and dispense a liquid in a state where a tip is attached to the end,
and the specimen treatment apparatus comprises a tip disposal part configured to be simultaneously accessed by the two dispensers and able to receive the tip removed from each of the two dispensers.

7. The specimen treatment apparatus according to claim 1, wherein the operating device is configured to suck and dispense a liquid with the two dispensers independently of each other and to move the two dispensers independently of each other in a vertical direction.
